(19) United States
(12) Patent Application Publication
(10) Pub. No.: US 2005/0199594 A1
(43) Pub. Date: Sep. 15, 2005

(54) Plasma cutting torch with differentiated gas injection ducts

(75) Inventor: Edmond Baillot, Bessancourt (FR)

Correspondence Address: Linda K. Russell, Suite 1800, 2700 Post Oak Blvd., Houston, TX, 77056, US

(73) Assignees: L'Air Liquide, Societe Anonyme Directoire et Conseil de Surveillance pour I'Etude et; I'Expoloitation des Procedes Georges Claude; La Soudure Autogene Francaise

(21) Appl. No.: 11/073,954

(22) Filed: Mar. 7, 2005

(30) Foreign Application Priority Data
Mar. 9, 2004 (FR) 0450477

(51) Int. Cl. B23K 9/00

(52) U.S. Cl. 219/121.48

(57) ABSTRACT

An apparatus and a method for plasma cutting metal. The plasma torch has a plasma chamber located on its main body. Both a cutting gas supply duct, and an ignition gas supply duct open into the plasma chamber. The ignition gas supply duct is partly separate from the cutting gas supply duct.

The present invention relates to a plasma arc working torch with differentiated gas injection ducts, in particular to a plasma cutting torch, to a unit comprising such a torch and to its use in a plasma cutting method.

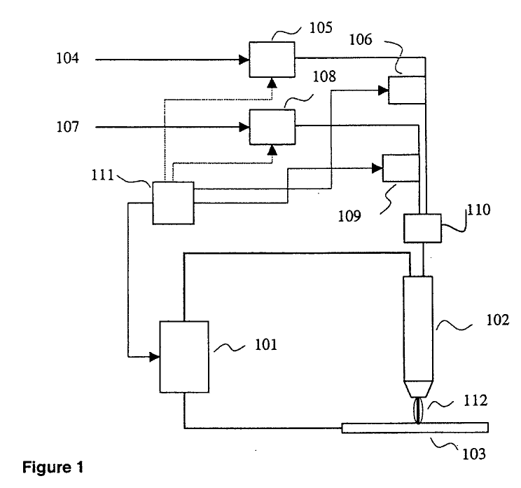

FIG. 1 shows a general diagram of a conventional plasma cutting unit, which generally comprises at least one electrical current supply 101 connected via its poles, on one side, to the electrode of a torch 102 and, on the other side, to the workpiece 103 to be cut, which forms the other electrode. An ignition gas or pilot gas supply 104 feeds the torch 102 via a pressure-regulating means 105 for regulating the pilot gas pressure. An isolating valve 106 and a device 110, which are internal or external to the torch, are used to control the relative flow in the various feed lines into the torch. The isolating valve 106 is used to open the pilot gas line into the torch 102 or to close it, depending on the sequencing steps associated with the cutting work. A cutting gas supply 107 feeds the torch 102 via a pressure-regulating means 108 for regulating the cutting gas pressure, an isolating valve 109 and a device 110 for controlling the relative flow in the feed lines into the torch 102. The cutting gas line can therefore be opened or closed depending on the sequencing steps associated with the cutting work.

Moreover, a controller 111 for controlling the operating sequences of the plasma cutting unit opens/closes the isolating valves 106 and 109 and increases/decreases the current from the electrical supply 101, both for the ignition phases and for the cutting phases.

If the pressure-regulating means 105 and 108 are not manually adjusted devices but devices that are remotely controllable according to an operating setpoint, the controller 111 also controls, before, simultaneously with or after the opening of the isolating valves 106 and 109, the operation of the regulating devices 105 and 108.

During a cutting operation, after the prior operations of striking an arc and of transferring it to the workpiece to be cut, the controller 111 commands, on the basis of information attesting the transfer of the arc, for example via a current sensor (not shown) placed in the electrical circuit connecting the electrical current supply 101 to the workpiece 103 to be cut, on the one hand, the replacement of the pilot gas with the cutting gas by causing the pilot gas isolating valve 106 to close and, almost simultaneously, causing the cutting gas isolating valve 109 to open, and, on the other hand, the rise in current from the electrical supply 101, as a predefined ramp in order to pass from the pilot current value to the cutting current value so as to establish a plasma arc 112 suitable for the cutting operation that has to follow.

When the pressure-regulating device 108 is a device that can be remotely controlled according to an operating setpoint, a predefined ramp for opening the said device 108 or for raising the pressure is commanded before, simultaneously with or after the command to open the isolating valve 109.

At the end of the cutting operation, through a predefined programme or upon an order by the operator, a cycle stop command is sent to the device 110, which then commands the electrical supply 101 to stop the current and, after a predefined delay, causes the cutting gas isolating valve 109 to close.

When the pressure-regulating device 108 is a device that can be remotely controlled according to an operating setpoint, the said device is controlled according to a predefined ramp for closing it, or for reducing the pressure, by the controller 111 before, simultaneously with or after closure of the cutting gas isolating valve 109.

However, this type of unit of the prior art has a number of drawbacks.

Thus, the design of the gas injection into the arc chamber or plasma chamber of the torch 102 usually results from a compromise between injection allowing a stable pilot arc to be established, an effective drilling phase, good cutting performance, and arc extinction without erosion of the consumable parts, i.e. essentially nozzle and electrode.

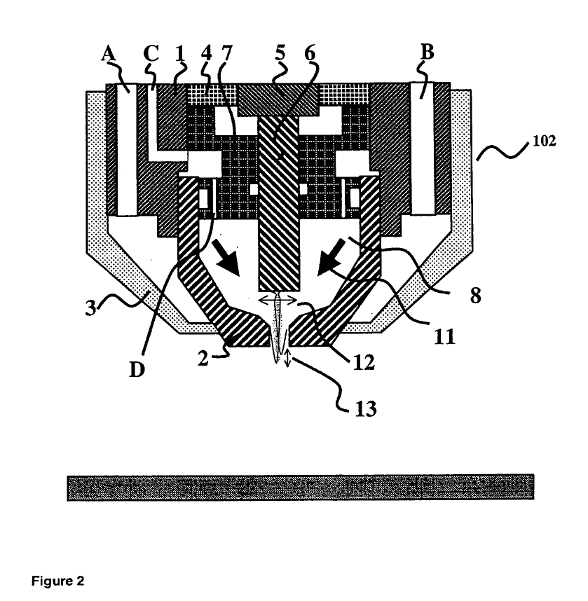

Despite the great complexity of the parameters that govern these various phases of the method, gas is injected into the torch via a single duct as shown in detail in FIG. 2.

The flow of gas thus obtained is generally designed to optimize the cutting performance in the steady state, to the detriment of the performance of the other steps of the cutting process.

More precisely, FIG. 2 shows the lower parts of a torch nose or head operating according to this principle, i.e. the torch 102 of FIG. 1.

In this figure may be distinguished the lower main body 1 of the torch 102, provided with a nozzle 2 held in position by a protective shroud 3, and an electrode 6 held in position relative to the nozzle 2 by a conducting electrode support 5 that also serves as electrical current lead.

The electrode 6 is connected to one of the terminals of the power generator, while being isolated from the nozzle 2 and from the nozzle support by an insulating insert 4.

Also shown in FIG. 2 is part of the internal fluid ducts for conveying the fluids (gas and liquid) within the cutting torch.

Thus, the supply duct A and return duct B for the heat-transfer liquid, such as for example distilled water, allow the heat received by the nozzle 2 during cutting to be carried away, so as to prevent the nozzle from bearing away too rapidly.

The gas is injected into the arc chamber 8, also called the plasma chamber 8, via calibrated orifices D that are fed via a single gas duct C and are supported by a diffuser 7. The dimensions and the distribution of the said orifices D of the diffuser 7 depend on the method chosen and on the working current chosen.

Other modes of gas injection into the arc chamber 8 also exist, such as annular throttling means or other similar means.

In such a torch of the prior art, only a single gas injection duct is therefore provided, irrespective of the phase of the process, that is to say the same duct serves for feeding with ignition gas and then with plasma gas. Similarly, the same orifices D of the diffuser 7 are used for the flow of the ignition gas and flow of the cutting gas.

Now, with such an arrangement it has been found that the ignition performance, that is to say the striking of the arc, is relatively poor and results in particular in stability problems and a short pilot arc.

The ignition pilot arc is established by arc blowing between electrode 6 and nozzle 2, whether in DC or AC, high-frequency or other polarization.

The characteristics of the pilot arc are dependent on the flow mode (arrows 11) of the pilot gas in the arc chamber 8, which are themselves determined by the injection characteristics: dimensions, number, orientation, etc. of the gas entry orifices D.

In this case, the flow mode, ill suited to the pilot arc, since it is designed to optimize cutting in the steady state, does not allow the arc root to be correctly stabilized on the electrode and this results in lateral excursions 12 of the arc.

Likewise, this flow does not make it possible to have constant electrical path lengths between electrode 6 and nozzle 2, which results in axial fluctuations (arrow 13).

In addition, the pilot arc is then poorly stabilized at the electrode 6, its length and its voltage are highly variable, and its mean length is sometimes too short. This has an adverse effect on arc transfer onto the workpiece 14.

The problem to be solved is therefore how to improve the torches of the prior art by proposing a particular arrangement of the plasma cutting torches for establishing various gas flow conditions depending on the operating phase, namely the ignition phase and the cutting phase, so as to be able to adapt the flow according to the intrinsic characteristics of each of the phases.

The solution of the invention is therefore a plasma torch having a main body comprising a plasma chamber and a first, working gas, feed duct that opens into the said plasma chamber in order to feed the said plasma chamber with working gas, characterized in that it includes a second, ignition gas, feed duct that opens into the said plasma chamber in order to feed the said plasma chamber with ignition gas, the said second, ignition gas, feed duct being at least partly separate from the first, working gas, feed duct.

Depending on the case, the torch of the invention may comprise one or more of the following technical features:
the first and second gas feed ducts are differentiated by the sites of entry of the cutting gas and ignition gas into the plasma chamber;
the sites of entry of the cutting gas into the plasma chamber are one or more first orifices and the sites of entry of the ignition gas into the plasma chamber are one or more second orifices, the said one or more first orifices being separate from the said one or more second orifices;
it includes means for controlling the flow of gas through the sites of entry of the cutting gas and the ignition gas into the plasma chamber;
the plasma chamber is fed with cutting gas via a plurality of calibrated orifices and the plasma chamber is fed with ignition gas independently, via a plurality of separate calibrated orifices;
the said one or more first orifices and the said one or more second orifices are provided within one or more diffusers; and
the first and second gas feed ducts and the said one or more first orifices and one or more second orifices are based and designed so as to allow the plasma chamber to be fed with working gas independently of the second, ignition gas, feed duct and to allow the plasma chamber to be fed with ignition gas independently of the first, working gas, feed duct.

The invention also relates to a plasma arc working unit comprising a torch according to the invention, in particular an automatic plasma cutting unit.

Depending on the case, the unit of the invention may furthermore include working gas feed means and ignition gas feed means, an electrical current supply and control means, in particular numerical control means.

According to another aspect, the invention also relates to a plasma cutting method for cutting a metal workpiece using such a torch or such a unit.

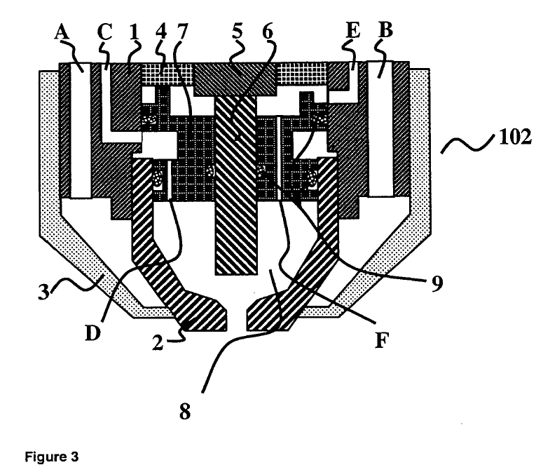

The invention will now be clearly understood thanks to the following detailed description given in conjunction with FIG. 3, which is a schematic representation of the downstream part, also called the nose or head, of a plasma torch according to the invention.

The torch according to the invention illustrated in FIG. 3 is overall similar to that illustrated in FIG. 2, except that the gas feed ducts are differentiated, there being a cutting gas injection duct C and a pilot gas or ignition gas injection duct E. Such feed differentiation allows better control of the way the plasma chamber 8 is fed with the various gases and therefore improves the performance of the gases according to their specific role in the sequencing of a cutting operation.

As may be seen in FIG. 3, the arc chamber 8 is fed with cutting gas via a plurality of calibrated orifices D and the arc chamber 8 is fed with pilot gas completely independently via a plurality of calibrated orifices F separate from the orifices D.

Differentiation and optimization of the gas flow rely on differentiated and staged injection, feeding a single diffuser 7 provided with sealing means 9, such as seals or the like, needed for effective differentiation of the gas ducts.

In other words, the pilot gas and the cutting gas do not travel along the same gas ducts in the torch body and are not delivered into the plasma chamber 8 via the same delivery orifices that pass through the diffuser 7.

It should be emphasized that instead of the single diffuser 7, it is possible to use several staged diffusers, for example a diffuser for the pilot gas and another diffuser for the cutting gas.

However, it is also possible to envisage using a single diffuser 7 whose fluid behaviour varies according to the gas to be delivered, for example that resulting in a change in flow mode, in particular depending on the gas feed pressure.

In all cases, thanks to the invention it is now possible to optimize the flow mode of the ignition gas and of the cutting gas, and the cutting characteristics are thus improved thereby.

Likewise, the ignition arc or pilot arc characteristics are also markedly improved since the arc is exceptionally stable and of great length. The results are even more significant as regards the constancy of transfer height, that is to say the distance between the end of the nozzle and the workpiece to be cut. The transfer height is defined as the height for which it is possible to switch from blown-arc mode to transferred-arc mode. This height is detected while keeping the two current return circuits, namely the nozzle circuit and the workpiece circuit simultaneously closed. A device for measuring the presence of current is provided on the workpiece circuit. During the pilot arc step, the torch is moved closer to the workpiece until current actually flows through the workpiece circuit. The transfer is semi-active. The transfer mode is then locked by opening the electrical circuit of the nozzle. All of the current then passes through the workpiece. Transfer is complete. Next, the drilling step can start, with a change in the nature of the gas (from pilot gas to cutting gas) and by progressively increasing the current.

This gas duct differentiation technique can be applied, for example, to optimizing the injection and the flow properties in respect of the workpiece drilling phase, after ignition, but this could be generalized to the drilling phase in laser cutting or water-jet cutting.

Thanks to the invention, the lateral blowing of the spatter of molten metal by the plasma jet, during drilling, can thus be better controlled. This helps greatly to increase the lifetime of the nozzles which, without optimization, are subjected to the impact of a considerable amount of molten metal spatter.

The various techniques used to convey gas right to the bottom of the torch body where the gas diffuser(s) can be found have not been taken into account in FIG. 3, since these techniques are already well known from the prior art.

The provisions of the invention are advantageously applicable to all plasma cutting torches, whether of the manual or automatic type, and irrespective of the applications: namely the cutting of structural steels, stainless steels, aluminium alloys and other metals that can be cut by a plasma cutting method; irrespective of the plasma-generating fluid used, namely liquid, pure gas or a mixture of several gases, whether of the oxidizing or non-oxidizing, neutral or chemically active, type, for example of the reducing type; and irrespective of the power of the plasma jet (or of the laser or water jet).

1-10. (canceled)

11. An apparatus which may be used as a plasma torch, said apparatus comprising:
a) a main body, wherein said main body comprises a plasma chamber;
b) a cutting gas supply duct, wherein said cutting gas duct:
1) opens into said plasma chamber; and
2) supplies said plasma chamber with a cutting gas; and
c) an ignition gas supply duct, wherein said ignition gas duct:
1) opens into said plasma chamber;
2) supplies said plasma chamber with an ignition gas; and
3) is at least partly separate from said cutting gas duct.

12. The apparatus of claim 11, wherein said first and said second ducts are differentiated by the sites of entry of said cutting gas and said ignition gas into said plasma chamber.

13. The apparatus of claim 11, further comprising:
a) at least one first orifice, wherein said first orifice connects said cutting gas duct to said plasma chamber; and
b) at least one second orifice, wherein said second orifice:
1) connects said ignition gas duct to said plasma chamber; and
2) is separate from said first orifice.

14. The apparatus of claim 13, further comprising a flow control means for controlling the flow of said cutting and said ignition gases through said first and said second orifices.

15. The apparatus of claim 11, wherein said plasma chamber:
a) is supplied with said cutting gas by a plurality of calibrated cutting gas orifices; and
b) is supplied with said ignition gas, independently, by a plurality of separate calibrated ignition gas orifices.

16. The apparatus of claim 13, further comprising at least one diffuser, wherein said first and said second orifices are located within said diffuser.

17. The apparatus of claim 13, wherein said cutting gas supply duct, said ignition gas duct, said first orifice, and said second orifice are configured such that said plasma chamber:
a) may be supplied with said cutting gas independently of said ignition gas duct; and
b) may be supplied with said ignition gas independently of said cutting gas duct.

18. An apparatus which may be used as a plasma arc cutting unit, comprising a plasma cutting torch, wherein said torch comprises:
a) a main body, wherein said main body comprises a plasma chamber;
b) a cutting gas supply duct, wherein said cutting gas duct:
1) opens into said plasma chamber; and
2) supplies said plasma chamber with a cutting gas; and
c) an ignition gas supply duct, wherein said ignition gas duct:
1) opens into said plasma chamber;
2) supplies said plasma chamber with an ignition gas; and
3) is at least partly separate from said cutting gas duct;
d) at least one first orifice, wherein said first orifice connects said cutting gas duct to said plasma chamber; and
e) at least one second orifice, wherein said second orifice:
1) connects said ignition gas duct to said plasma chamber; and
2) is separate from said first orifice.

19. The apparatus of claim 18, wherein said apparatus is an automatic plasma cutting unit.

20. The apparatus of claim 18, further comprising:
a) a cutting gas supply means;
b) an ignition gas feed means; and
c) an electrical current supply and control means.

21. The apparatus of claim 20, wherein said electrical current supply and control means comprises a numerical control means.

22. A method which may be used for cutting a metal work piece, said method comprising cutting a metal work piece with a plasma arc cutting unit, wherein said unit comprises:
a) a cutting gas supply means;
b) an ignition gas feed means;
c) an electrical current supply and control means; and
d) a torch, wherein said torch comprises:
1) a main body, wherein said main body comprises a plasma chamber;
2) a cutting gas supply duct, wherein said cutting gas duct:
i) opens into said plasma chamber; and
ii) supplies said plasma chamber with a cutting gas from said cutting gas supply means; and
3) an ignition gas supply duct, wherein said ignition gas duct:
i) opens into said plasma chamber;
ii) supplies said plasma chamber with an ignition gas from said ignition gas supply means; and
iii) is at least partly separate from said cutting gas duct.
